(19) United States
(12) Patent Application Publication
(10) Pub. No.: US 2016/0224664 A1
(43) Pub. Date: Aug. 4, 2016

(54) FREE ASSOCIATION ENGINE TO GENERATE AND OPERATE ON DYNAMIC VIEWS OF STORED ENTITIES AND ASSOCIATIONS DERIVED FROM RECORDS OF USER ENCOUNTERS WITH PHYSICAL OBJECTS AND OTHER INPUT DATA SOURCES

(71) Applicant: Aura Network, Inc., San Francisco, CA (US)

(72) Inventors: Christina Frances Regina Noren, San Francisco, CA (US); Daniel John Cooley, San Francisco, CA (US); Karen Ye Sun, San Francisco, CA (US)

(73) Assignee: Aura Network, Inc.

(21) Appl. No.: 14/611,977

(22) Filed: Feb. 2, 2015

(51) Int. Cl. G06F 17/30

(52) U.S. Cl. CPC G06F 17/30722; G06F 17/30247; G06F 17/30958; G06F 17/30905

(57) ABSTRACT

The embodiments described herein comprise a free association engine running on a server for capturing input data and recorded observations received from one or more electronic devices or other sources, optionally during user encounters with physical objects associated to the input data and observations; deriving underlying entities and associations of the input data using rules applied to the input data and observations; storing the derived entities and associations in a graph or triplestore database; executing dynamic operations based on the derived entities and associations; and generating visualizations concerning the express and inferred entities and associations. The embodiments allow a user to create rules that are applied to input data and observations to generate entities and associations. The embodiments provide the ability to generate dynamic views of the derived entities and associations based upon a user's selection of sources of the input data and observations and use these views to visualize the data in different ways to different users under different circumstances and power semantically precise user searches and automated recommendations.

### TECHNICAL FIELD

The embodiments described herein comprise a free association engine running on a server for capturing input data and recorded observations received from one or more electronic devices or other sources, optionally during user encounters with physical objects associated to the input data and observations; deriving underlying entities and associations of the input data using rules applied to the input data and observations; storing the input data, recorded observations, and derived entities and associations in a graph or triplestore database; executing dynamic operations based on the derived entities and associations; and generating visualizations concerning the derived entities and associations. The embodiments allow a user to create rules that are applied to input data and observations to generate entities and associations. The embodiments provide the ability to generate dynamic views of the derived entities and associations based upon a user's selection of sources of the input data and observations and use these views to visualize the data in different ways to different users under different circumstances and power semantically precise user searches, automated recommendations and other dynamic application logic.

### BACKGROUND OF THE INVENTION

The prior art includes embodiments for collecting data from various sources and categorizing the data through manual tagging by human beings. For example, a music provider might manually tag each piece of music to indicate its genre (e.g., contemporary jazz). Users thereafter can search for music based on genre. Other fields can be created and populated as well, but the data is generated through tedious manual tagging by human beings.

Graph databases also are known in the prior art. In a prior art graph database, nodes represent entities, and the edges between nodes represent associations between the entities. This is illustrated in FIG. 13, which depicts graph database 1300. Graph database 1300 comprises nodes 1310, 1320, and 1330. Between nodes 1310 and 1320 are edges 1312 and 1314; between nodes 1320 and 1330 are edges 1322 and 1324; and between nodes 1330 and 1310 are edges 1332 and 1334. Node 1310 represents a person, John, and node 1320 represents another person, Sandra. Node 1330 represents an activity, Acme website. John is a blogger for Acme website, and Sandra is a designer for Acme website. Edges 1312, 1314, 1322, 1324, 1332, and 1334 capture the associations between the entities represented by the nodes. However, in prior art graph systems, the associations or edges are fixed by the programmer or architect, and new associations or edges are not added dynamically. In addition, prior art graph systems do not enable the use of edges between other edges.

What is lacking in the prior art is a free association engine that can analyze input data received from one or more electronic devices or other sources and derive and store underlying entities and associations (such as object encountered by a user at place with GPS coordinates of lat 40.7614327 and long −73.97762160000002 has label “title=“Demoiselles d'Avignon” and artist=Pablo Picasso” and “medium=oil on canvas” so it is an object located at the known place “Museum of Modern Art” that is previously known to contain the GPS coordinates of lat 40.7614327 and long −73.97762160000002 that is a manifestation of the creative work named “Demoiselles d'Avignon” with an association of “created by” to a previously known person named “Pablo Picasso” and an association to the previously known medium/technique “oil on canvas”). What is further lacking are additional inferred associations of that input data (such as “Demoiselles d'Avignon is a cubist painting”) by applying rules to the associations to derive additional associations without requiring a human being to manually tag the data. What is further lacking is the ability for a user to create rules that can be used to generate inferred associations. What is further lacking is the ability for a user to generate visualizations of a prioritized subset of the input data based upon a user's selections and priorities of known attributes of sources of the input data (for example, to display genre information based solely on express associations or inferred associations generated from input data collected from reputable critics). What is further lacking is the use of a graph database that allows new associations or edges to be created dynamically. What is further lacking is a graph database that allows for associations or edges between other associations or edges. What is further lacking is the ability for application logic to traverse multiple degrees of associations or edges, such as searching for paintings created by artists of Native American descent that were associated as students or academic colleagues of a given other artist.

### SUMMARY OF THE INVENTION

The embodiments described herein comprise a free association engine running on a server for capturing input data and recorded observations received from one or more electronic devices or other sources, optionally during user encounters with physical objects associated to the input data and observations; deriving underlying entities and associations of the input data using rules applied to the input data and observations; storing the input data, recorded observations, and derived entities and associations in a graph or triplestore database; executing dynamic operations based on the derived entities and associations; and generating visualizations concerning the input data and express and inferred associations. The embodiments allow a user to create rules that are applied to input data and observations to generate entities and associations. The embodiments provide the ability to generate dynamic views of the derived entities and associations based upon a user's selection and prioritization of attributes of sources of the input data and observations and use these views to visualize the data in different ways to different users under different circumstances and power semantically precise user searches and automated recommendations. The embodiments utilize a graph or triplestore database that allows new associations or edges to be created dynamically. The graph or triplestore database allows for associations or edges between other associations or edges. The graph or triplestore database allows for application logic to traverse multiple levels of edges or associations.

### BRIEF DESCRIPTION OF THE DRAWINGS

FIG. 1 depicts hardware components of a computing device

FIG. 2 depicts software components of a computing device.

FIG. 3 depicts computing devices in communication with a server and a database.

FIG. 4 depicts objects and associated communication devices.

FIG. 5 depicts an exemplary user interface on a computing device for obtaining input data from a user.

FIG. 6 depicts a free association engine running on a server.

FIG. 7 depicts other aspects of a free association engine running on a server.

FIG. 8 depicts the use of rules to generate derived entities and associations based on input data and recorded observations.

FIG. 9 depicts the selection of input data and recorded observations by a user to generate data subsets.

FIG. 10 generation of visualizations of data subsets.

FIG. 11 depicts an exemplary visualization concerning the reaction of User X to various objects.

FIG. 12 depicts an exemplary visualization concerning the reactions of various subsets of users to a particular object.

FIG. 13 depicts a prior art graph database.

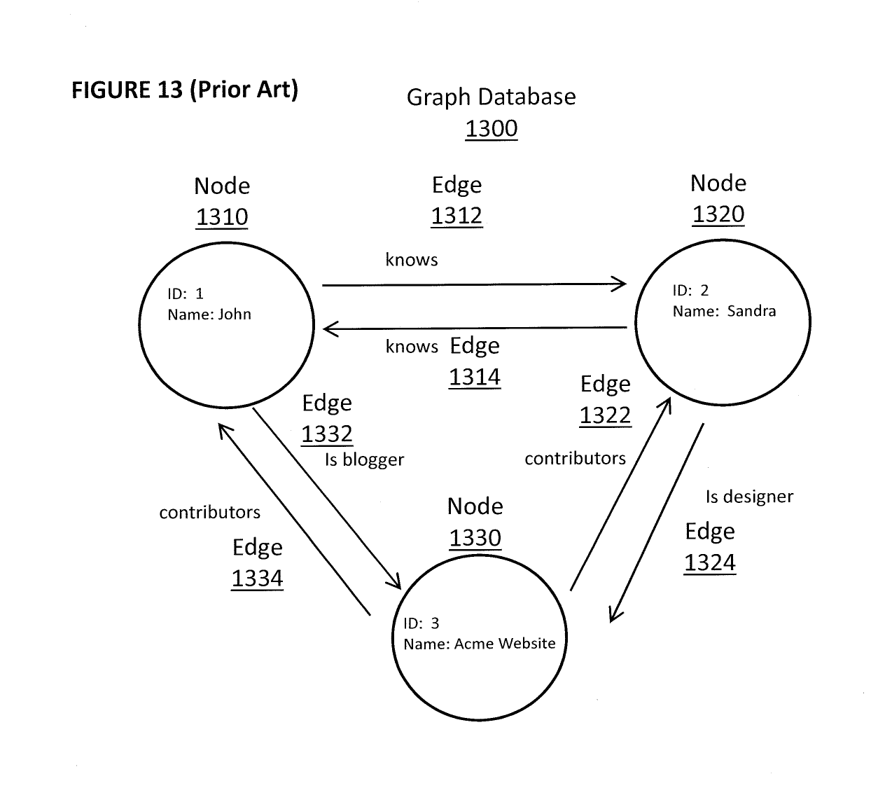

FIG. 14 depicts a graph database used in the embodiments of the invention.

### DETAILED DESCRIPTION OF THE PREFERRED EMBODIMENTS

Hardware and Software Components

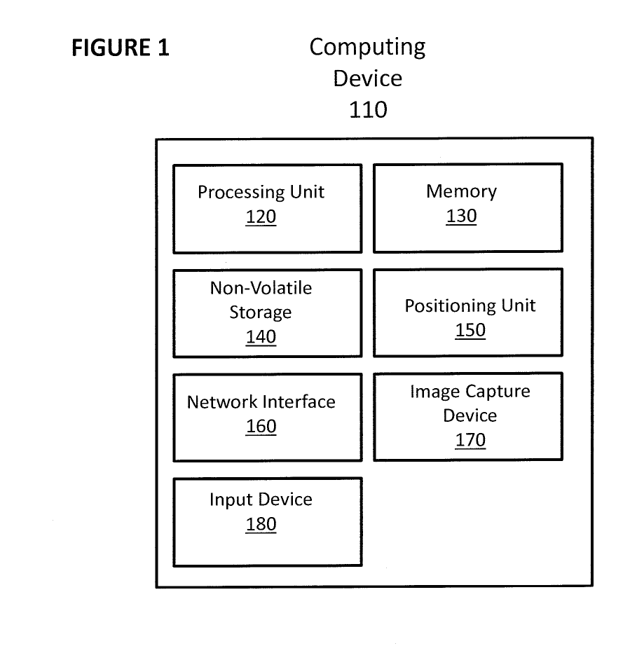

With reference to FIG. 1, computing device 110 is depicted. Computing device 110 can be a desktop, notebook, server, mobile device, tablet, automobile device, wearable device, or any other computer with network connectivity. Computing device 110 comprises processing unit 120, memory 130, non-volatile storage 140, positioning unit 150, network interface 160, image capture unit 170, and input device 180. Non-volatile storage 140 can comprise a hard disk drive or solid state drive. Positioning unit 150 can comprise a GPS unit. Network interface 160 can comprise an interface for wired communication (e.g., Ethernet) or wireless communication (e.g., 3G, 4G, GSM, 802.11). Image capture unit 170 can comprise a camera (e.g., a mobile phone camera or webcam). Input device 180 can comprise a keyboard, mouse, touchscreen, microphone, motion sensor, and/or other input device.

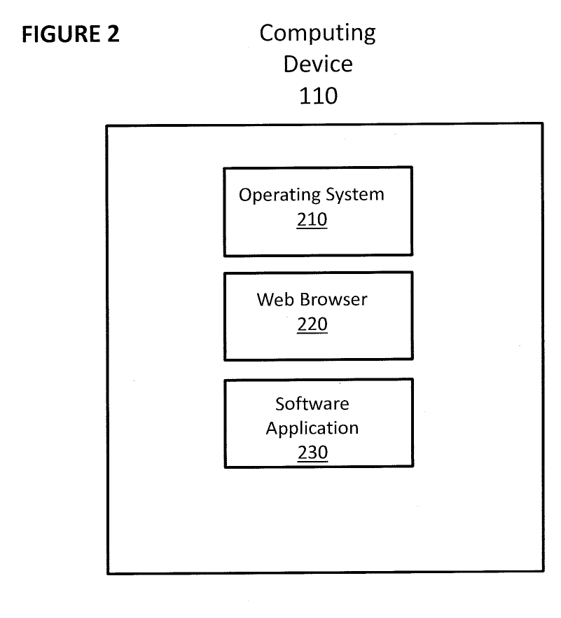

With reference to FIG. 2, software components of computing device 110 are depicted. Computing device 110 comprises operating system 210 (such as Windows, MacOS, Android, or iOS), web browser 220 (such as Chrome, Internet Explorer, or Firefox) and software application 230. Operating system 210, web browser 220, and software application 230 each comprise lines of software code that can be stored in memory 130 and executed by processing unit 120.

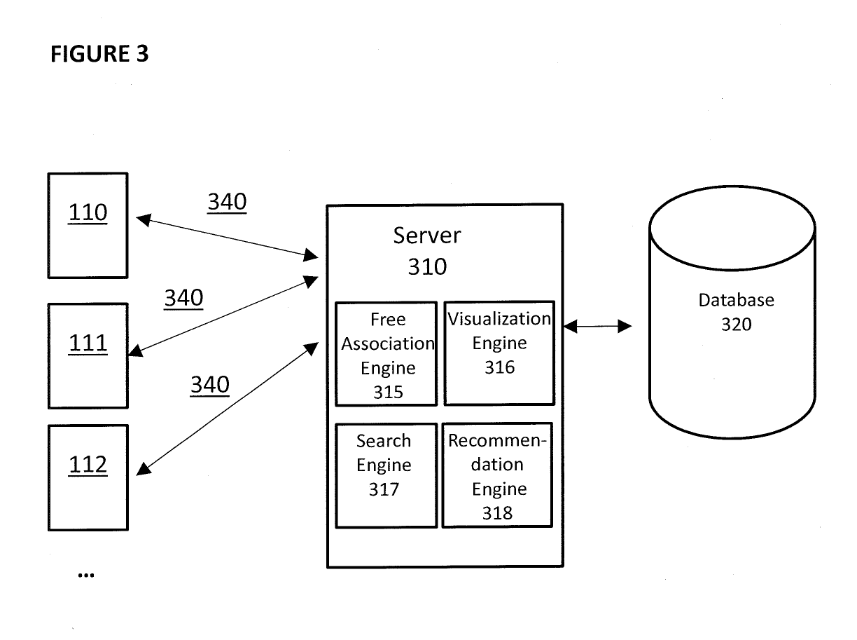

With reference to FIG. 3, computing device 110 communicates with server 310 over network 340 using network interface 160. Server 310 accesses database 320, either over network 340 or another connection. Network 340 can comprise the Internet, a local area network (LAN), or other network. Computing device 110 is exemplary, and one of ordinary skill in the art will appreciate that an unlimited number of devices can exist and can communicate with server 310. For example, computing devices 111 and 112 (which can include the same type of hardware and software components described previously for computing device 110) also communicate with server 310 over network 340.

Server 310 can comprise the same hardware components and software components described previously for computing device 110. In addition, server 310 comprises free association engine 315, visualization engine 316, search engine 317, and recommendation engine 318. Free association engine 315, visualization engine 316, search engine 317, and recommendation engine 318 each comprise lines of software code that can be stored in memory and executed by a processing unit within server 310.

Generation and Collection of Input Data and Recorded Observations

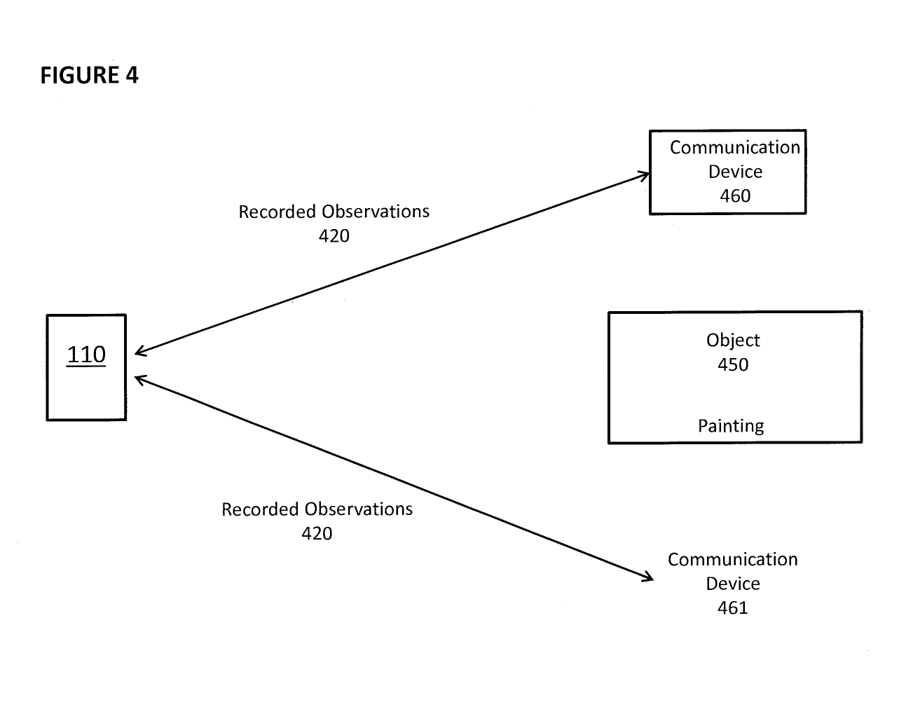

With reference to FIG. 4, object 450 is a physical object. In one example, object 450 is a painting on display in a museum. Communication devices 460 and 461 are located physically near object 450. If object 450 is a painting on display in a museum, then communication devices 460 and 461 can be attached to the wall or pedestal near object 450.

In one embodiment, communication devices 460 and 461 are wireless beacons that emit a signal, which is a type of recorded observation 420, and the strength of the signal as received by computing device 110 enables computing device 110 to determine the relative proximity of object 450 to computing device 110 using well-known triangulation techniques.

In another embodiment, communication devices 460 and 461 are wireless appliances that can communicate with computing device 110 (and/or other computing devices such as computing devices 111 or 112) using a network or link. The network or link can comprise a wireless or wired network or link, such as the Internet, a local area network, an 802.11 network, Bluetooth, or other RF communication.

Computing device 110 can capture input data 520 and recorded observations 420 relating to object 450 in a multitude of different ways. For example, computing device 110 can be used to take a photograph (another example of input data 520) of object 450 or of placards or other posted information regarding object 450 using image capture device 170 and can then perform optical character recognition to extract text (another form of input data 520) from the placards or posted information. Computing device 110 can record the date, time, and location (further examples of recorded observations 420) of the encounter with object 450. Computing device 110 can obtain input data 520 from the user of computing device 110 through web browser 220 or software application 230. A non-exhaustive list of examples of such input data 520 that can be obtained from the user of computing device 110 includes the exemplary fields shown in Table 1:

TABLE 1
name of object
author of object
year of creation of object
medium
size of object
materials used in object
whether the user likes the object
how the user feels when he or she views the object
the posted or verbally quoted price for the object
the colors of the object
other physical characteristics of the object
other objects that the user believes are similar to this object
other notes input by the user
biological data regarding the user, such as heart rate or blood pressure

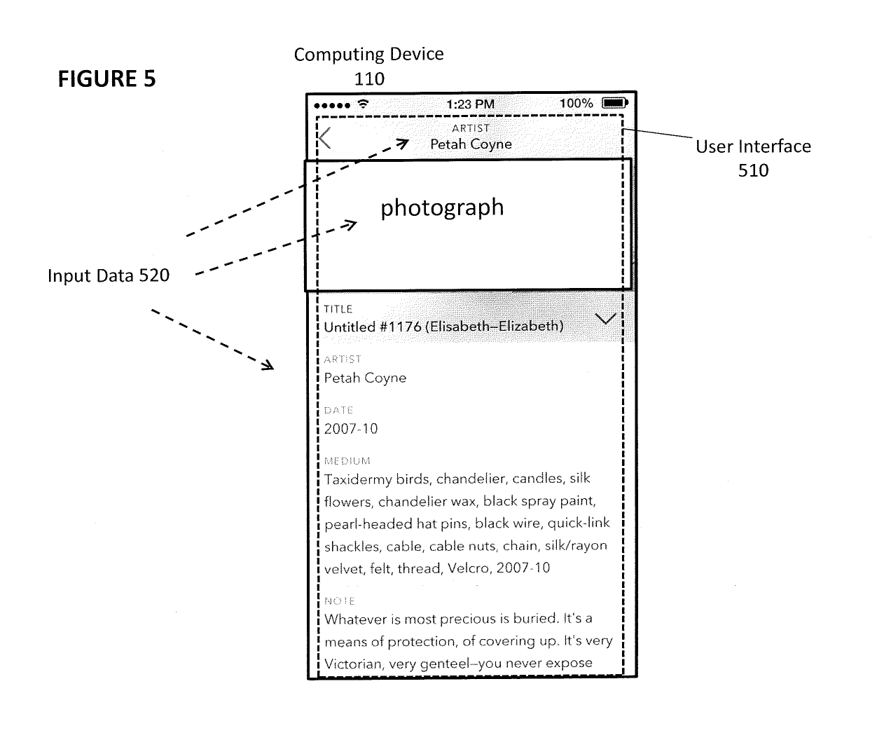

An example of this process is shown in FIG. 5. FIG. 5 depicts exemplary user interface 510 generated by software application 230 or web browser 220 on computing device 110. User interface 510 receives input data 520 from the user of computing device. In this example, the user inputs input data 520 into the fields of Table 1 as shown in Table 2:

TABLE 2

| FIELD | DATA |
|---|---|
| name of object | Untitled #1176 (Elisabeth-Elizabeth) |
| author of object | Petah Coyne |
| year of creation of object | 2007-10 |
| medium | Taxidermy birds, chandelier, candles, |
| | silk flowers, chandelier wax, black |
| | spray paint, pearl-headed hat pins, |
| | black wire, quick-link shackles, |
| | cable, cable nuts, chain, |
| | silk/rayon velvet, felt, thread, |
| | Velcro, 2007-10 |
| size of object | |
| materials used in object | |
| whether the user likes the object | |
| how the user feels when he or | |
| she views the object | |
| the colors of the object | |
| other physical characteristics | |
| of the object | |
| other objects that the user believes | |
| are similar to this object | |
| other notes input by the user | |
| biological data regarding the user, | |
| such as heart rate or blood pressure | |

Input data 520 also can be collected from other computing devices, such as computing devices 111 and 112, as well as the users of such devices. Computing devices such as computing devices 110, 111, and 112 can be servers as well. For example, if computing device 112 is a server, then collected data from computing device 112 might comprise data that is scraped from a website operated by computing device 112 or data that is provided by computing device 112 in response to a query, request, or API. For example, if computing device 112 operates an information website such as Wikipedia or an art catalog database, and data can be obtained from computing device 112 using an API.

Input data 520 also can comprise data about a user. For example, if User X is a user of computing device 110, he or she can enter profile information about himself or herself, such as “User X is male/female” or “User X is 42 years old.” Input data 520 can comprise data about the user's specific expertise in an area, such as number of years of formal education in a subject, degrees obtained, number of years working in the relevant industry, certification and licenses received, number of peer-reviewed publications, etc. Input data 520 also can relate to any entity stored in database 320, such as persons (including users, authors, artists, etc.), organizations, places, concepts, events, objects, or other entities.

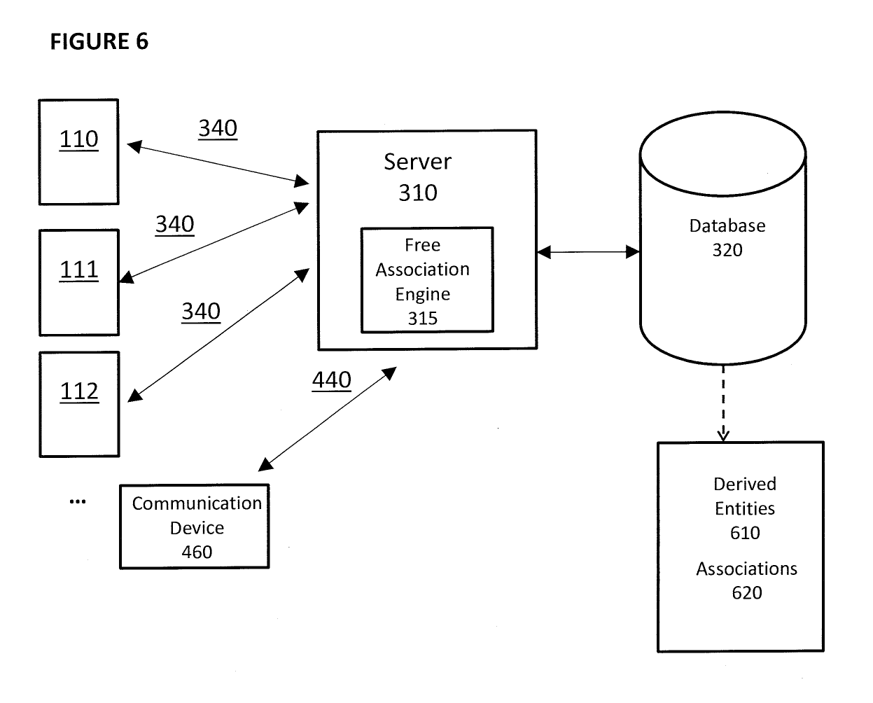

With reference to FIG. 6, database 320 receives input data 520 and recorded observations 420 from a variety of sources, such as computing devices 110, 111, 112, or other computing devices and communication devices 460, 461, or other communication devices. Database 320 stores input data 520 and recorded observations 420 as well as derived entities 610 and associations 620 that are generated by free association engine 315 Database 320 preferably is a triplestore database or graph database. In general, associations 620 and will be of the form SUBJECT-ASSOCIATION-OBJECT and can be retrieved by a user through semantic queries. Derived entities 610 comprise subjects and objects, which can then be stored in associations 620.

Examples of types of associations 620 are shown in Table 3:

TABLE 3

| ASSOCIATION | POSSIBLE SUBJECTS | POSSIBLE OBJECTS |
|---|---|---|
| is AuraID of | AuraID | specific person |
| generated | AuraID | Record |
| was recorded in | Note | Record |
| said | specific person | Note |
| wrote | specific person, AuraID | Note |
| translated | specific person, AuraID | Note |
| reported | Record | Association |
| is the tag for | Tag | Note |
| is a note about | Note | [any entity] |
| is the language/dialect of | language/dialect | Note |
| is a translation of | Note | Note |
| is the same as | [any entity] | [any entity of same type] |
| Is the opposite of | [any entity] | [any entity of same type] |
| is similar to | [any entity] | [any entity of same type] |
| is the plural of | [any entity] | [any entity of same type] |
| is part of | [any entity] | [any entity of same type] |
| is an example of | [any entity] | [any entity of same type] |
| is the plural of | [any entity] | [any entity of same type] |
| is a pair of | [any entity] | [any entity of same type] |
| became | [any entity] | [any entity of same type] |
| is a known attribute of | Attribute | specific work, specific thing |
| is defined by | Attribute | Association, association type |
| is a descriptor of | Descriptor | Association, specific work, |
| | | specific person, specific |
| | | organization, specific thing, |
| | | Movement/Trend, specific |
| | | event, Time, Element, idea |
| is closely associated with | [any entity] | [any entity] |
| evokes | specific work, specific thing | specific person, specific |
| | | work, specific thing, |
| | | Movement/Trend |
| is quantity of | number | Association |
| is a rating of | rating | [any entity] |
| is a manifestation of | specific thing, media file, | specific work |
| | specific place | |
| is an adaptation of | specific work | specific work |
| is a web address of | URL | specific work |
| is a performance of | specific event | specific work |
| is a showing of | specific event | specific work |
| is a fragment of | specific thing, media file | specific work |
| is a study/model/sketch/ | specific thing, specific work | specific work |
| maquette for | | |
| is documentation of | specific thing, media file | specific work |
| is a component of | specific thing, media file | specific work |
| is a prop for | specific thing | specific work |
| is an artifact of | specific thing | specific work, specific event |
| is a frame for | specific thing | specific work |
| is part of | specific thing | specific work |
| is a capture of | specific media file | specific thing, specific event, |
| | | specific place, specific |
| | | person, specific animal |
| is a capture type of | specific media file | capture type |
| is part of | specific work | specific work |
| is an edition of | specific work | specific work |
| is an episode of | specific work | specific work |
| is the edition type of | edition type | specific work |
| is a model of | specific work | specific work |
| is a number of | specific thing | specific work |
| is the unique manifestation of | specific thing | specific work |
| is a reproduction of | specific work, specific thing | specific work, specific thing |
| is a forgery of | specific work, specific thing | specific work, specific thing |
| is a printing of | specific work | specific work |
| is a production of | specific work | specific work |
| is an issue of | specific work | specific work |
| is the brand of | specific work | specific work |
| is an example of | specific thing | specific work |
| is the model year of | year | specific work |
| is the issue date of | Time | specific work |
| is the issue date start of | Time | specific work |
| is the issue date end of | Time | specific work |
| created | specific person, specific | specific work |
| | organization, specific animal | |
| designed | specific person, specific | specific work |
| | organization | |
| invented | specific person, specific | specific work |
| | organization | |
| composed | specific person | specific work |
| wrote | specific person | specific work |
| edited | specific person, specific | specific work |
| | organization | |
| curated | specific person, specific | specific work |
| | organization | |
| posed for | specific person, specific | specific work |
| | organization | |
| performed in | specific person, specific | specific work, specific event |
| | organization | |
| sponsored/backed/funded | specific person, specific | specific work, specific event |
| | organization | |
| promoted | specific person, specific | specific work, specific event |
| | organization | |
| manufactured | specific person, specific | specific work |
| | organization | |
| made | specific person, specific | specific work |
| | organization | |
| captured | specific person | media file |
| was made in | specific thing | specific place |
| was made by | specific thing | culture |
| is an example of | specific work | Movement/Trend |
| was associated with | specific person, specific | Movement/Trend |
| | organization | |
| was influenced by | specific work, specific | specific work, specific |
| | person, specific organization, | person, specific organization, |
| | Movement/Trend | Movement/Trend |
| was derivative of | specific work, specific | specific work, specific |
| | person, specific organization, | person, specific organization, |
| | Movement/Trend | Movement/Trend |
| paid homage to | specific work, specific | specific work, specific |
| | person, specific organization, | person, specific organization, |
| | Movement/Trend | Movement/Trend |
| appropriated | specific work, specific | specific work, specific |
| | person, specific organization, | person, specific organization, |
| | Movement/Trend | Movement/Trend |
| reacted against | specific work, specific | specific work, specific |
| | person, specific organization, | person, specific organization, |
| | Movement/Trend | Movement/Trend |
| criticized | specific work, specific | specific work, specific |
| | person, specific organization, | person, specific organization, |
| | Movement/Trend | Movement/Trend |
| is a subject of | Work, Person, Organization, | specific work, Movement/ |
| | Animal, Place, Thing, | Trend, style/genre |
| | Movement/Trend, Event, | |
| | Time, Concept | |
| is a theme of | Work, Person, Organization, | specific work, Movement/ |
| | Animal, Place, Thing, | Trend, style/genre |
| | Movement/Trend, Event, | |
| | Time, Concept | |
| is text in | Note | specific work |
| symbolizes | Person, Animal, Place, | idea |
| | Thing, Element | |
| is a/the format of | format | Work, specific thing, |
| | | Movement/Trend, style/ |
| | | genre |
| is a/the medium of | medium/technique | Thing, style/genre |
| is a material used in | thing type, substance/ | Thing, medium/technique |
| | material | |
| is a technique used in | medium/technique | Work, Thing |
| is a tool used for | thing type | Work, Thing, medium/ |
| | | technique |
| is the style of | style/genre | specific work, specific thing, |
| | | Movement/Trend |
| is the genre of | style/genre | specific work, specific thing, |
| | | Movement/Trend |
| are the dimensions of | dimensions | specific thing |
| is the dimensionality of | dimensionality | Thing |
| is a color in | color | specific work, specific thing, |
| | | media file, Movement/ |
| | | Trend, style/genre |
| is an element in | Element | specific work, specific thing, |
| | | media file, Movement/ |
| | | Trend, style/genre |
| is a shape in | shape | specific work, specific thing, |
| | | media file, Movement/ |
| | | Trend, style/genre |
| is a pattern or motif in | pattern/motif | specific work, specific thing, |
| | | media file, Movement/ |
| | | Trend, style/genre |
| is a symbol or icon in | symbol/icon | specific work, specific thing, |
| | | media file, Movement/ |
| | | Trend, style/genre |
| is a musical scale in | musical scale | specific work, specific thing, |
| | | media file, Movement/ |
| | | Trend, style/genre |
| is a sound in | sound | specific work, specific thing, |
| | | media file, Movement/ |
| | | Trend, style/genre |
| is an optical effect in | optical effect | specific work, specific thing, |
| | | media file, Movement/ |
| | | Trend, style/genre |
| is a taste of | taste | specific work, specific thing, |
| | | media file, Movement/ |
| | | Trend, style/genre |
| is the smell of | smell | specific work, specific thing, |
| | | media file, Movement/ |
| | | Trend, style/genre |
| is the feel of | feel | specific work, specific thing, |
| | | media file, Movement/ |
| | | Trend, style/genre |
| is the language of | language/dialect | specific work |
| uses | specific work | specific work |
| is written in | specific work | specific work |
| depends on | specific work | specific work |
| references | specific work | specific work |
| quotes | specific work | specific work |
| is the brand of | specific work | specific person, specific |
| | | organization |
| is the logo of | specific work | specific person, specific |
| | | organization |
| is the signature/mark of | specific work | specific person, specific |
| | | organization |
| is a patent on | specific work | specific work |
| is a patent held by | specific work | specific person, specific |
| | | organization |
| is a trademark of | specific work | specific person, specific |
| | | organization |
| is a copyright held by | specific work | specific person, specific |
| | | organization |
| is licensed under | specific work | specific work |
| is a | specific person | person type |
| is a | specific animal | animal type |
| is a | specific media file | media format |
| is a | Record | Aura record type |
| is a | specific work | work type |
| is a | specific organization | organization type |
| is a | specific place | place type |
| is a | specific thing | thing type |
| is a | exhibit | exhibit type |
| is a | specific person | art participant type |
| is a | specific event | event/activity type |
| is a | specific work | edition type |
| was identified as | specific person | specific person |
| is related to | specific person | specific person |
| is the parent of | specific person | specific person |
| is the grandparent of | specific person | specific person |
| is the sibling of | specific person | specific person |
| is an ancestor of | specific person | specific person |
| is the spouse of | specific person | specific person |
| is the life partner of | specific person | specific person |
| taught | specific person | specific person |
| studied with | specific person | specific person |
| associated with | specific person | specific person |
| was friends with | specific person | specific person |
| collaborated with | specific person | specific person |
| was romantically linked with | specific person | specific person |
| participated in | specific person | specific event |
| was the principal of | specific person | specific event |
| is the web address of | URL | specific person, specific |
| | | organization, specific work |
| studied at | specific person | Organization |
| was a member of | specific person | Organization |
| was employed by | specific person | Organization |
| founded | specific person | Organization |
| represents | specific person, specific | specific person, specific |
| | organization | organization |
| advises | specific person, specific | specific person, specific |
| | organization | organization |
| specializes in | specific person, specific | [any entity] |
| | organization | |
| was the formal organization of | specific organization | Movement/Trend, religion/ |
| | | sect, nationality, Place |
| is a part of | specific organization | specific organization |
| is/was the founding place of | specific place | specific organization |
| is/was the founding date of | Time | specific organization |
| was the founding event of | specific event | specific organization |
| is the headquarters of | specific place, Location | specific organization |
| is a location of | specific place, Location | specific person, specific |
| | | organization |
| is a culture of | culture | specific place, Person |
| is a nationality of | nationality | specific place, Person |
| is a language spoken in | language/dialect | specific place |
| is a language spoken by | language/dialect | culture, Person |
| is the racial identity of | race | Person |
| is a religion of | religion/sect | Person |
| is the gender of | gender | Person |
| is a diagnosis of | disease/disorder/condition | Person |
| is a psychographic type of | psychographic type | Person |
| is a profession of | profession/field/discipline | Person |
| is a job held by | job | Person |
| is the field of | profession/field/discipline | Organization |
| is an interest of | event/activity type, idea | Person |
| is/was the birthplace of | Place | specific person |
| is/was the birth date of | Time | specific person |
| is/was a place active of | Place | specific person, specific |
| | | organization |
| is/was the period active of | Time | specific person, specific |
| | | organization |
| is/was the start of activity of | Time | specific person, specific |
| | | organization |
| is/was the end of activity of | Time | specific person, specific |
| | | organization |
| is/was the deathplace of | Place | specific person |
| is/was the death date of | Time | specific person |
| held | specific person | position |
| is a position with | position | Organization |
| is a position doing | position | job |
| was granted | specific person | degree |
| granted | Organization | degree |
| studied at | specific person | Organization |
| studied | specific person | educational program/class |
| graduated from | specific person | Organization |
| owns | specific person, specific | specific thing |
| | organization | |
| lent | specific person, specific | specific thing |
| | organization | |
| lent to | specific thing | specific person, specific |
| | | organization |
| stole | specific person, specific | specific thing, Work |
| | organization | |
| recovered | specific person, specific | specific thing, Work |
| | organization | |
| destroyed | specific person, specific | specific thing, Work |
| | organization | |
| sold | specific person, specific | specific thing, Work |
| | organization | |
| sold to | specific thing, Work | specific person, specific |
| | | organization |
| transferred | specific person, specific | specific thing. Work |
| | organization | |
| transferred to | specific thing, Work | specific person, specific |
| | | organization |
| inherited from | specific person, specific | specific thing, Work |
| | organization | |
| inherited | specific thing, Work | specific person, specific |
| | | organization |
| donated | specific person, specific | specific thing, Work |
| | organization | |
| donated to | specific thing, Work | specific person, specific |
| | | organization |
| authenticated | specific person, specific | specific thing |
| | organization | |
| made for | specific thing | specific person, specific |
| | | organization |
| commissioned by | specific thing | specific person, specific |
| | | organization, position |
| worn by | specific thing | specific person, specific |
| | | organization, position |
| restored by | specific thing | specific person, specific |
| | | organization |
| disputed | specific person, AuraID | association |

The associations and entities in Table 3 are merely exemplary. Unlike in prior art systems, users can add new associations or entities to the system.

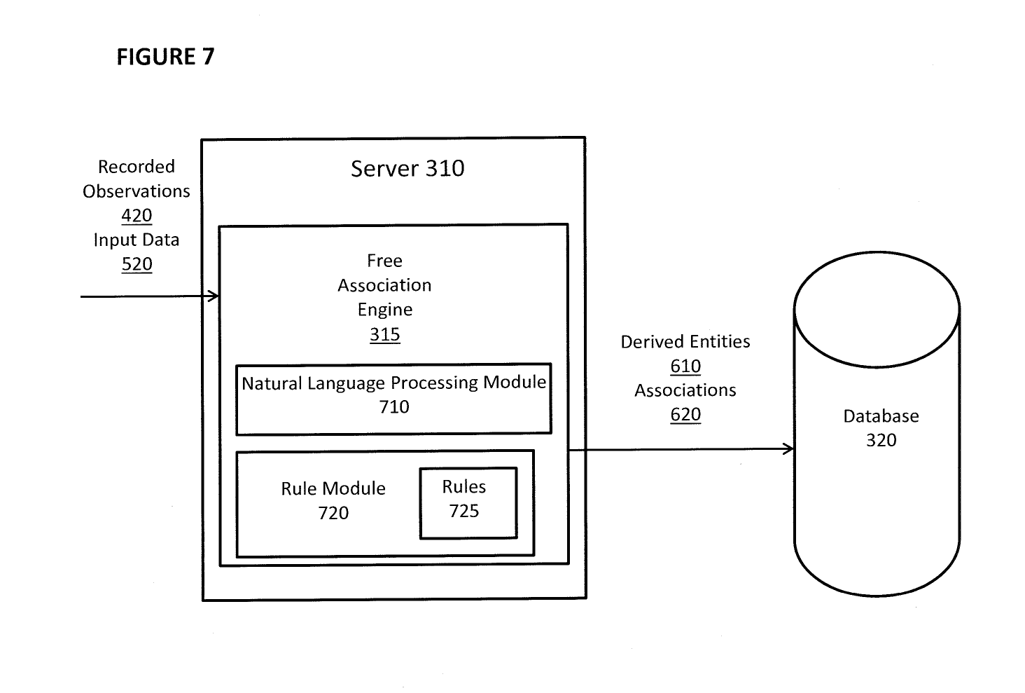

With reference to FIG. 7, natural language processing module 710 parses input data 520 and recorded observations 420 to determine derived entities 610 (subjects and objects) and rule module 720 determines associations 620 (the relationship between derived subjects and objects) by applying rules 725 to input data 520. This process can be assisted through the nature of a user interface, such as user interface 510, in web browser 220 or software application 230. For example, types of associations 620 can be offered to a user as options, and the user can select the association that is appropriate for the data that is being entered as input data 520.

Generation of Derived Entities and Associations Using Rules

With reference to FIG. 7, free association engine 315 generates entities 610 and associations 620 by applying a plurality of rules 725 on input data 520 and recorded observations 420 using rule module 720. Free association engine 315 then stores derived entities 610 and associations 620 in database 320 for storage. Free association engine 315 will match derived entities 610 and associations 620 derived from new input data 520 and recorded observations 420 with existing derived entities 610 and associations 620 already stored in databased 320.

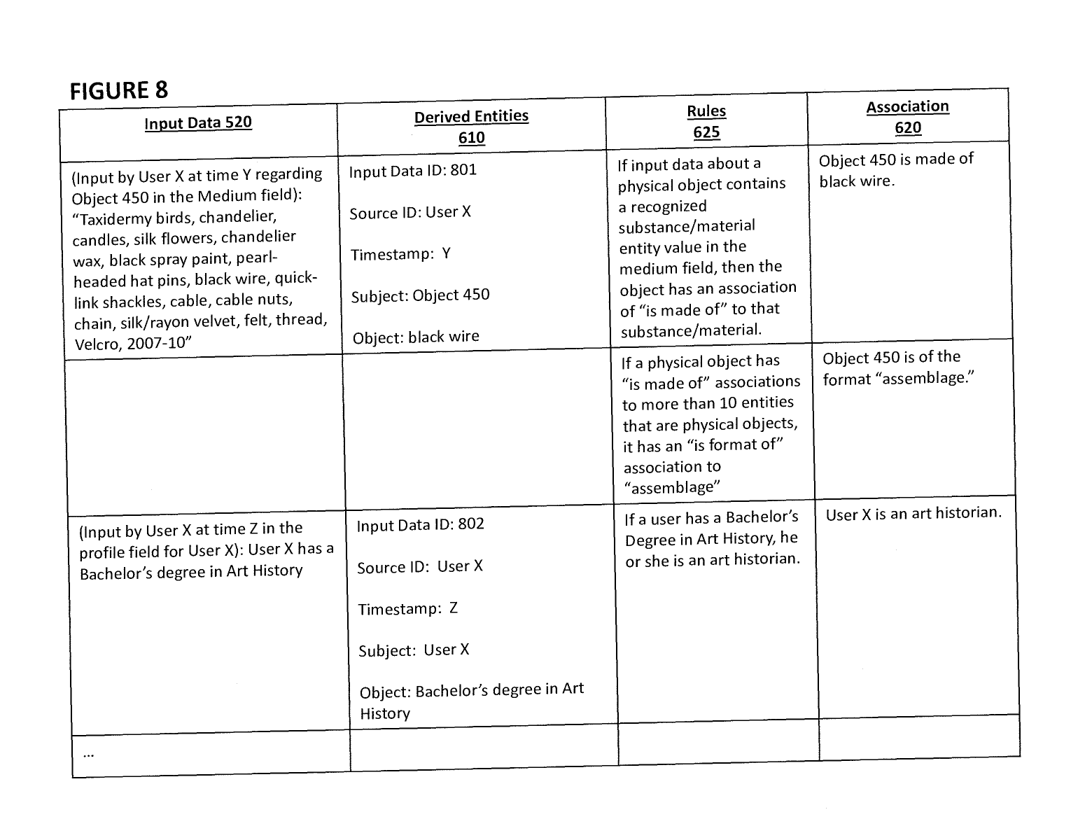

FIG. 8 depicts examples of how free association engine 315 generates derived entities 610 applied by natural language processing module 710 and associations 620 using rules 725 applied by rule module 720 to input data 520 and recorded observations 4200.

Other examples of rules 725 are shown in Table 4 below. It is to be understood that rules 725 can comprise thousands of rules. Rules 725 can be established by a user, website or application administrator, or an organization such as a museum.

TABLE 4
If a medium/technique entity is associated to a format, such as “oil on
canvas” to “painting”, then works associated to that medium/technique
should be automatically associated to the format
If an artist is associated to a single or primary movement/trend during a
given period and a work is associated to that artist completed on a date
within that association, the work should also be directly associated to
that movement/trend

Optionally, User X can extend free association engine 315. For example, User X can create his or her own set of rules to add to rules 725. For example, User X might create an rule that states, “If the painting was created by an artist active between two dates, then it was created between those dates.” Optionally, only users with certain privileges or credentials (e.g., museum curators; art appraisers; art historians; administrators; etc.) will be allowed to create rules 725.

Thus, database 320 can collect input data 520 and metadata 630 from a variety of sources, can collect or derive associations 610, and can generate associations 620 using rules 725, including rules created by users.

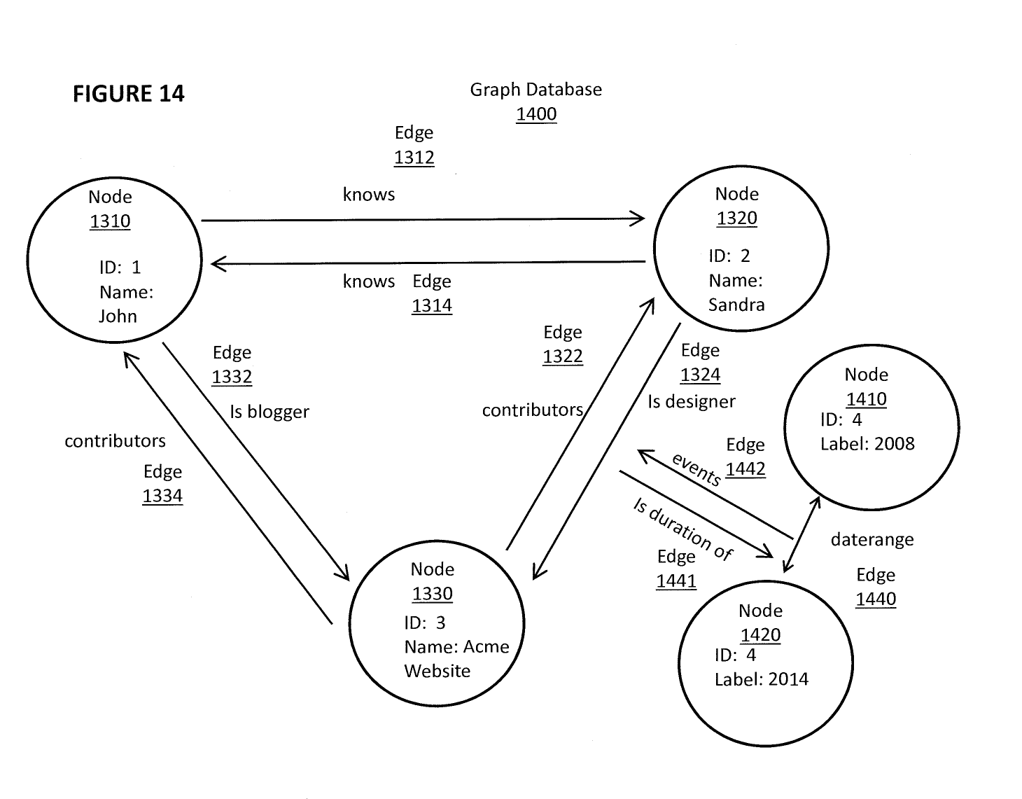

A comparison of the embodiments described herein to the prior art can be seen in FIG. 14. Graph database 1400 is an example of database 320. Graph database 1400 can utilize nodes 1310, 1320, 1330 and edges 1312, 1314, 1322, 1324, 1332, and 1334 as in prior art graph database 1300. However, the embodiments also allow users to create new associations or edges, such as edge 1440, which captures the additional association that date entity node 1410 “2008” was the start of a daterange, and date entity node 1420 “2014” was the end of one. The embodiments also allow for associations or edges to be generated between other associations or edges. For example, edge 1441 captures an association between edge 1324 and edge 1440. In this example, edge 1441 represents the association of “is duration of between edge 1324 “Sandra Jones is the designer of Acme Website” to the association “2008 was the start of a daterange and 2014 was its end” (edge 1440),

Dynamic Views of Input Data, Recorded Observations, Derived Entities, and Associations to Drive Visualizations, Searches, or Recommendations

A user can instruct server 310 to generate a dynamic view of derived entities 610, and/or associations 620 using only those derived from a subset of input data 520 and/or recorded observations 420 and prioritizing the display and use of different sources within that subset. For example, a user might wish to see a visualization of all input data 520 collected regarding Object 450 (e.g., a specific painting), or the user might wish to see a visualization of only the derived entities and associations from input data 520 regarding Object 450 that was collected from specific sources, such as users who are reputable art critics or museum curators. Optionally, the user also can specify a priority for the dynamic view, for example, by ordering the derived entities 610 and associations 620 within the dynamic view based on reputation or ranking data received for each source (e.g., applying greater weight to data derived from a source who has the strongest reputation as indication by reputation-related associations stored in database 320 to that source).

In another example, the user can establish a prioritization for entities and associations and that prioritization can be used to create or order the dynamic view of derived entities 610 and/or associations 620 (e.g., applying a date cutoff for the creation date of the input data 520 or recorded observations 420 from which the derived entities 610 or associations 620 were created and arranging the results based on creation date from most recent to least recent).

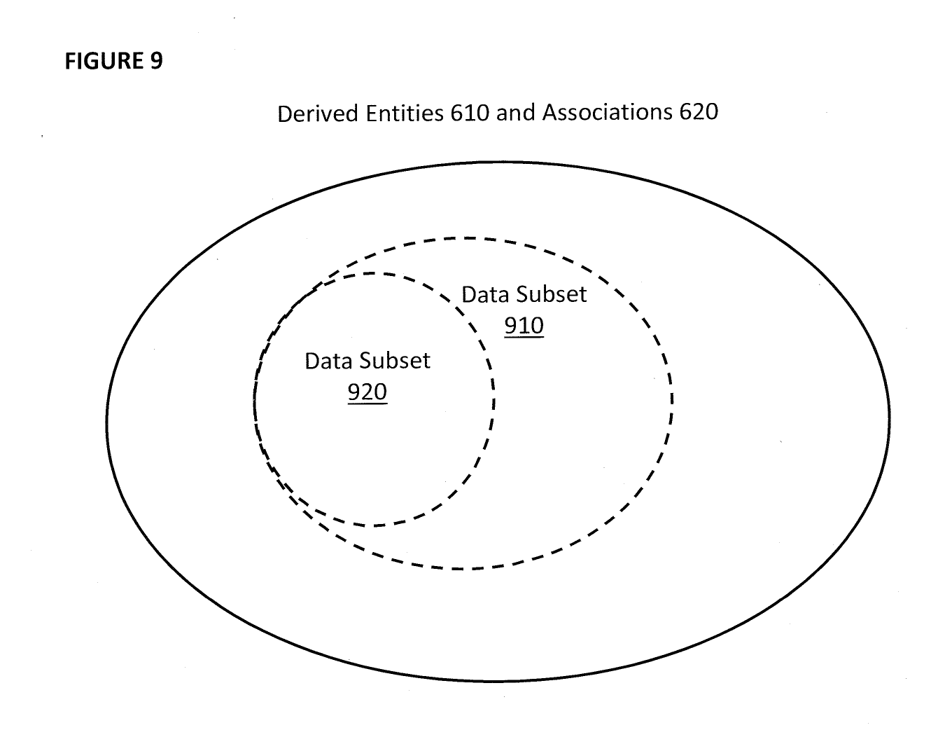

This is shown in FIG. 9, where all derived entities 610 and associations 620 regarding Object 450 are shown as exemplary data subset 910, and derived entities 610 and associations 620 regarding Object 450 that was collected from input data 520 originating from sources that meet a certain criteria is shown as exemplary data subset 920.

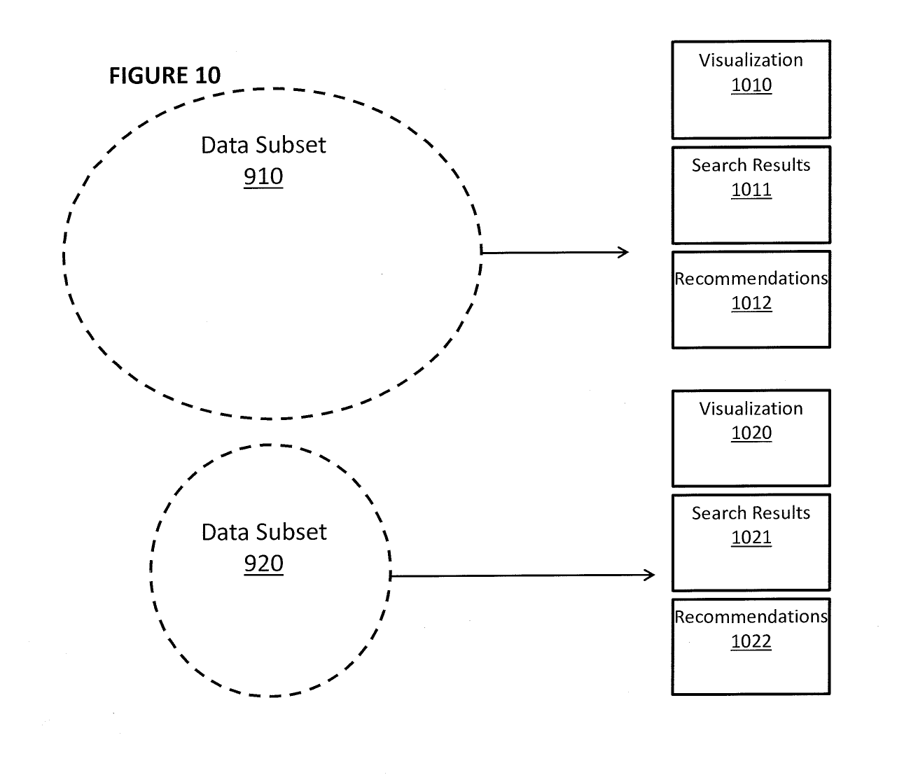

With reference to FIG. 10, once data subset 910 is created, the user can instruct server 310 to generate visualization 1010 of data subset 910 using visualization engine 316, to perform a search within data subset 910 to generate search results 1011 using search engine 317, or to provide recommendations 1012 based on data subset 910 using recommendation engine 318. Unlike in the prior art, search engine 317 and recommendation engine 318 will have the ability not only to operate on a subset of associations and entities but also to traverse and combine associations.

Similarly, once data subset 920 is created, the user can instruct server 310 to generate visualization 1020 of data subset 920 using visualization engine 316, to perform a search within data subset 920 to generate search results 1021 using search engine 317, or to provide recommendations 1022 based on data subset 920 using recommendation engine 318.

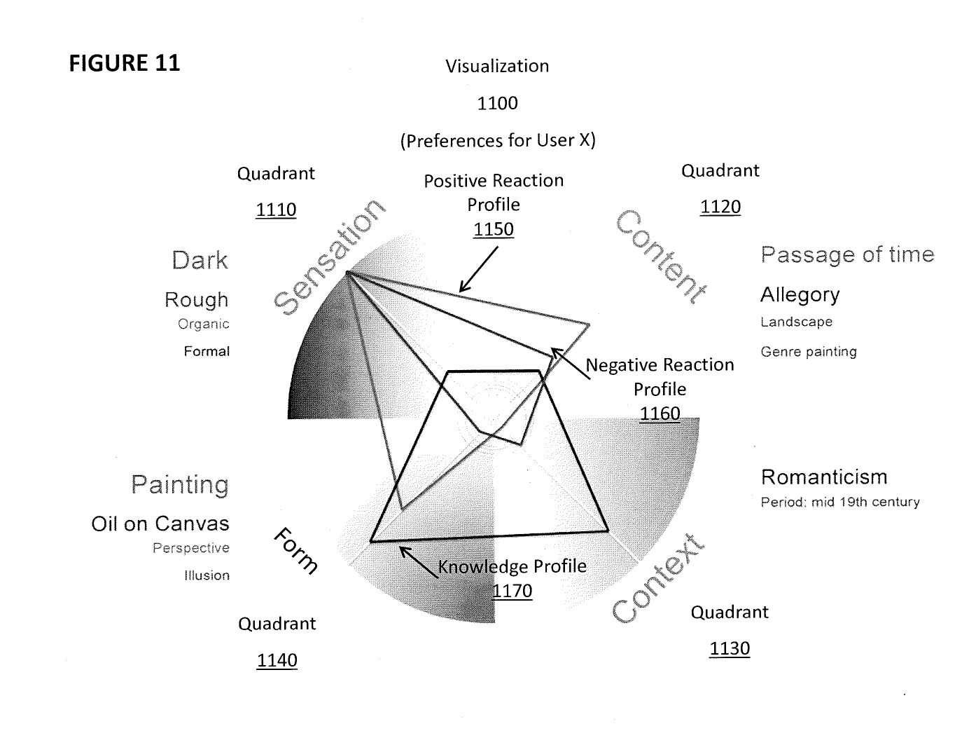

With reference to FIG. 11, an example of a visualization 1100 (which is an example of visualization 1010 or 1020 from FIG. 10) that can be used for a specific type of data subset generated by an inquiry is shown. In this example, visualization 1100 is used to show aspects of data subset regarding User X's preferences for art.

Visualization 1100 comprises a graph comprising four quadrants: quadrant 1110 indicates Sensation, quadrant 1120 indicates Content, quadrant 1130 indicates Context, and quadrant 1140 indicates Form.

Visualization 1100 depicts positive reaction profile 1150, negative reaction profile 1160, and knowledge profile 1170. Each of these profiles 1150, 1160, and 1170 is generated using input data 520, express associations 610, and inferred associations 620 that are associated with User X and reflects aspects of art that User X likes, dislikes, and knows about, respectively. Each of the profiles 1150, 1160, and 1170 comprises a point in each of the quadrants 1110, 1120, 1130, and 1140. Visualization 1100 thus can show User X what aspect evokes the most positive or negative feelings in User X. For example, positive reaction profile 1150 and negative reaction profile 1160 both indicate that Sensation is an important quality for User X. User X might like dark artwork but dislike rough artwork. Visualization 1100 also shows User X what aspects he or she is most knowledgeable about.

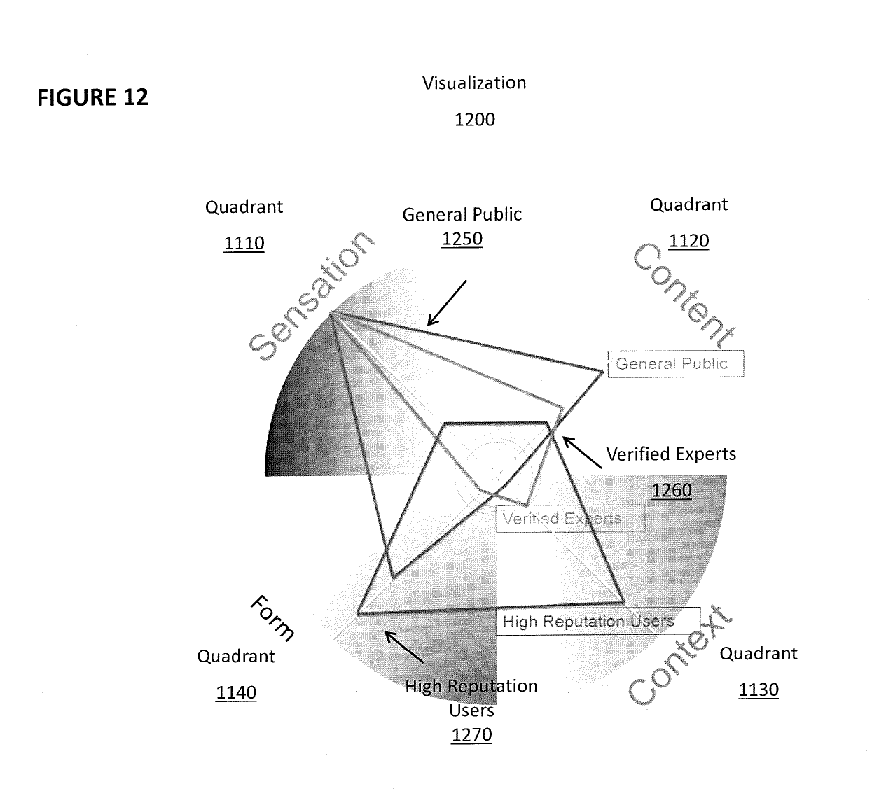

With reference to FIG. 12, an example of a visualization 1200 (which is an example of visualization 1010 or 1020 from FIG. 10) specific to an object, such as object 450, is depicted. Visualization 1200 comprises a graph with four quadrants: quadrant 1110 indicates Sensation, quadrant 1120 indicates Content, quadrant 1130 indicates Context, and quadrant 1140 indicates Form, as in FIG. 11.

Visualization 1200 depicts views of subsets of users, specifically, general public view 1250, verified experts view 1260, and high reputation users view 1270. Each of these views 1250, 1260, and 1270 is generated using a data subset limited to users of a certain background (determined by analyzing metadata 630), which in this example includes normal users, verified experts (such as art historians or museum curators), and high reputation users (such as serious art collectors), respectively.

Each of the views 1250, 1260, and 1270 comprises a point in each of the quadrants 1110, 1120, 1130, and 1140. Visualization 1200 thus can show what aspects of object 450 most resonated with each collection of users. In this example, Sensation was most important to the general public view 1250 and verified experts view 1260, but Form and Context were most important to high reputation users view 1270 as to object 450.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims. It should be noted that, as used herein, the terms “over” and “on” both inclusively include “directly on” (no intermediate materials, elements or space disposed there between) and “indirectly on” (intermediate materials, elements or space disposed there between). Likewise, the term “adjacent” includes “directly adjacent” (no intermediate materials, elements or space disposed there between) and “indirectly adjacent” (intermediate materials, elements or space disposed there between).

What is claimed is:

1. A method of operating a free association engine on a server, comprising:
establishing, in response to a user command, a rule;
receiving, by the server, input data from a computing device;
deriving, by the free association engine, entities from the input data; (rules drive both the entities and association derivation)
applying, by the free association engine, the rule to the input data to generate one or more associations between the entities; and
storing, by a graph database, the input data, entities and associations.

2. The method of claim 1, wherein the input data comprises a photograph.

3. The method of claim 1, wherein the input data comprises a creator name.

4. The method of claim 1, wherein the input data comprises text.

5. The method of claim 1, further comprising:
establishing, in response to a user command, a user-established association.

6. The method of claim 5, wherein the applying step comprises generating the user-established association between the entities.

7. The method of claim 1, further comprising:
receiving, by the server, recorded observations.

8. The method of claim 7, wherein the recorded observations comprise location information for an object.

9. The method of claim 8, wherein the location information is derived from a signal received by the computing device from a communication device.

10. The method of claim 4, wherein the text information is derived from applying optical character recognition to images of printed materials captured in a photograph captured by the computing device.

11. A method of operating a free association engine on a server, comprising:
receiving, by the server, a request from a computing device, the request specifying source criteria for entities and association stored in a graph database; and
generating, by the server and the graph database, a dataset comprising entities and associations derived from input data associated with the source specified by the source criteria.

12. The method of claim 11, further comprising:
generating, by the server, a visualization of the dataset.

13. The method of claim 11, further comprising:
executing, by the server, a search within the dataset.

14. The method of claim 11, further comprising:
providing, by the server, a recommendation based on the dataset.

15. The method of claim 11, wherein the source criteria comprises one or more of the following: associations within the dataset to the source including gender, race, academic credentials, age, personal history, job experience, activities, or memberships.

16. A server operating a free association engine and a graph database, the graph database capable of storing entities and associations, wherein the server is configured to:
establish, in response to a user command, a rule;
derive, using the free association engine, one or more new entities from one or more of: input data received by the server from a computing device, one or more existing entities stored in the graph database, or one or more existing associations between existing entities stored in the graph database;
apply the rule to generate one or more associations involving the one or more of the new entities; and
store in the graph database the one or more new entities and one or more associations involving the one or more new entities.

17. The server of claim 16, wherein the server is further configured to:
establish, in response to a user command, a user-established association.

18. The server of claim 16, wherein the server is further configured to:
receive a request from a computing device specifying source criteria for entities and associations stored in the graph database; and
generate a dataset comprising entities and associations derived from input data or recorded observations associated with sources matching the source criteria.

19. The server of claim 16, further comprising:
a visualization engine for generating a visualization of the dataset.

20. The server of claim 16, further comprising:
a search engine for performing a search within the dataset.

21. The server of claim 16, further comprising:
a recommendation engine for providing a recommendation based on the dataset.
